(19) United States
(12) Patent Application Publication
(10) Pub. No.: US 2006/0036526 A1
(43) Pub. Date: Feb. 16, 2006

(54) Cash flow monitoring mechanism and methodology

(75) Inventors: Alexander Ramos, Ridgewood, NJ (US); Timothy Overzat, Warren, NJ (US); William J. Yung, Brooklyn, NY (US)

Correspondence Address: PILLSBURY WINTHROP SHAW PITTMAN, LLP, P.O. BOX 10500, MCLEAN, VA, 22102, US

(73) Assignee: THE BANK OF NEW YORK, New York, NY (US)

(21) Appl. No.: 11/196,730

(22) Filed: Aug. 4, 2005

Related U.S. Application Data
(60) Provisional application No. 60/601,140, filed on Aug. 13, 2004.

(51) Int. Cl. G06Q 40/00

(52) U.S. Cl. 705/35

(57) ABSTRACT

A system, system component and methodology support compliance with fund and advisor policies and procedures designed to prevent the violation of federal securities laws by determining an indication of whether a fund's value is potentially being affected by market timing practices. At least one algorithm is utilized to perform analysis of categories of fund transaction data to yield an indication of the presence of market timing practices.

This application is related to and claims priority under 35 U.S.C. 120 from co-pending provisional U.S. Patent Application Ser. No. 60/601,140, titled “Chief Compliance Officer Services Support System and Methodologies,” filed Aug. 13, 2004, and the concurrently filed, non-provisional United States Patent Application entitled “Regulation Compliance Monitoring, Reporting and Documentation Support System,” the contents of which are incorporated herein by reference.

### BACKGROUND OF THE INVENTION

1. Field of the Invention

This invention relates to a system and methodologies for performing the monitoring of fund cash flows as a means to perform surveillance of market timing activities.

2. Description of Related Art

The United States Securities and Exchange Commission (SEC) has mandated that mutual funds and their investment advisors perform increased monitoring and oversight to ensure compliance with United States federal securities laws which prohibit and or restrict, amongst other things, some types of market timing activity. Such prohibited practices involve the buying of fund shares when their current value is greater than a fund Net Asset Value (NAV) and selling the funds when the reverse is true; such practices undermine the value of fund shares to the long term investor.

A mutual fund is generally required to compute its Net Asset Value (NAV) at least once each business day at a specific time or times as determined by its board. Typically, this calculation is performed once each business day, at or near, the close of the major U.S. securities exchanges and markets (usually 4:00 p.m., Eastern Time (“ET”)). Market timing practices seek to manipulate the time delay between market closings globally.

Funds must calculate their NAVs using the market value of their portfolio securities when market quotations for those securities are readily available. However, when market quotations for a portfolio security are not readily available, a fund must calculate its NAV using the fair value of that security, as determined in good faith by the fund's board. Funds generally calculate their NAVs by using the closing prices of portfolio securities on the exchange or market (whether foreign or domestic) on which the securities principally trade.

However, a majority of foreign markets operate during a time period that is inconsistent with those of the major U.S. markets, e.g., Asian markets. As a result, closing prices of securities that principally trade on foreign exchanges or markets (“foreign securities”) may be upto fifteen hours old when used for NAV calculation. Therefore, those closing prices may not reflect the current market values of those securities. For example, if one or more events has occurred subsequent to the foreign markets closing, the closing prices of foreign securities may not reflect their current market values. Accordingly, although closing market prices may be used to value a mutual fund's portfolio securities, when the fund includes securities that are principally traded in non-U.S. markets, such valuation can result in allowing short-term investors to take advantage of the arbitrage opportunity created by what is in effect a timing difference to increase their return at the expense of long-term investors.

As an illustrative example, suppose a decline in the Asia market causes the value of securities held by a particular fund to decrease. Subsequent to the Asian market closing, the U.S. markets open and trading in other instruments indicates a likelihood that, when the Asian market reopens, subsequent to the trading day closing in the U.S., the value of the securities included in the fund (and hence, the NAV of the fund) will increase. As a result, investors may time the purchase shares of the fund in an attempt to take advantage of potentially undervalued fund shares.

This is because, at the end of the U.S. trading day, use of the securities' share prices formulated at the close of the Asian market results in a NAV that fails to take into consideration the likely increase in share prices in the Asian market by taking into consideration events subsequent to the close of the Asian market, e.g., by evaluating trading of other instruments and subsequent trading in other markets. As a result, when the Asian market rebounds on the subsequent day, as projected, and closes at a higher level, investors who bought fund shares at the previous day's NAV (calculated using Asia's closing market prices) may have a profit as a result of their purchase of undervalued fund shares.

Though a strategy, the resulting profits are gained at the expense of long-term investors of the fund whose share value was temporarily reduced even though the value of the fund's underlying assets was unchanged. This is because such a reduction represents profits taken by the short-term, redeeming investors.

Thus, funds may dilute the value of their shareholders' interests if they calculate their NAVs using closing prices that were established before a significant event has occurred. Dilution generally may occur, for example, if fund shares are overpriced because redeeming shareholders will receive a windfall at the expense of the shareholders that remain in the fund. Similarly, dilution may occur when a fund sells its shares at a price lower than its NAV. In such situations, short-term investors may attempt to exploit the discrepancies between market prices that are no longer current, and the values of a fund's portfolio securities.

Therefore, when left unchecked the use of closing market prices for valuation of securities traded in non-U.S. markets that are principally traded on non-U.S. markets, can potentially reduce the value of fund shares for long-term investors.

### SUMMARY OF THE INVENTION

However, fund administrators can implement processes and rules aimed at curbing the possibility of such activities such as fair valuing securities, requiring that shares be held for a period of time, instituting a burdensome transaction fee on shares that are bought and sold in a specified, short period of time, etc. Nevertheless, identifying market timing activity within a fund is key to determining both the need to implement such policies and the efficacy of such implemented policies. As such, 38(a)-1 of the Investment Company Act (originally enacted 1940), requires that a fund must have procedures reasonably designed to ensure compliance with its disclosed policies regarding market timing. These procedures should provide for monitoring of shareholder trades or flows of money in and out of the funds in order to detect market timing activity . . . Thus, in accordance with at least one embodiment of the invention, a mechanism is provided for monitoring such trades and flows for the purpose of identifying potential market timing activity that might be significant to the fund.

### BRIEF DESCRIPTION OF THE DRAWINGS

Various embodiments of the invention are described herein wherein like reference numerals indicate like components.

FIG. 1 illustrates an example of an environment wherein one or more Clients of an organization providing a Chief Compliance Officer (CCO) Support System including a cash flow monitoring mechanism interact with the CCO Support System.

FIG. 2 illustrates a hierarchical structure of a CCO Support System that may include a cash flow monitoring mechanism implemented in accordance with at least one embodiment of the invention;

FIG. 3 illustrates additional details of one exemplary architecture for the cash flow monitoring mechanism included in the CCO Support System;

FIG. 4 illustrates one example of a table listing an example of cash flow monitoring data; and

FIG. 5 illustrates one example of a graphical depiction of find activity consistent with detected market timing activity.

### DETAILED DESCRIPTION OF THE INVENTION

In accordance with various embodiments of the invention, a system, system component and methodology support compliance with fund and advisor policies and procedures designed to prevent the violation of federal securities laws by determining an indication of whether a fund is being subjected to market timing practices significant to it. At least one algorithm is utilized to perform analysis of categories of fund transaction data to yield an indication of the presence of market timing practices.

As a preliminary matter, an explanation is provided of the environment in which cash flow monitoring mechanism and methodologies may be implemented. It should be understood that the cash flow monitoring mechanism may be implemented as a component that may stand alone or be part of a more comprehensive service system. For example, the cash flow monitoring mechanism may be implemented as part of a system that provides information to a Chief Compliance Officer (CCO) who is responsible for administering various legally mandated policies and procedures and reporting on their adequacy and effectiveness to mutual fund boards of directors. Such a system (referred to herein, as a CCO Support System) may include components configured to deliver functional data, on a timely basis, to assist a CCO in measuring the effectiveness of fund and advisor policies and procedures designed to prevent the violation of federal securities laws. Throughout the further explanation of the embodiments of the invention, the term “CCO” broadly refers to Chief Compliance Officers, their staff and personnel acting at their direction. Additionally, the term “Client” refers to a financial investment entity, e.g., an organization that is utilizing the services provided by a CCO Support System.

Thus, a CCO Support System may be configured to monitor and document post-trade compliance of Client fund portfolios, fund cash flows and fair valuation practices. Additionally, such a CCO Support System may include components configured to provide a repository of documentation required to be maintained by the new CCO rules.

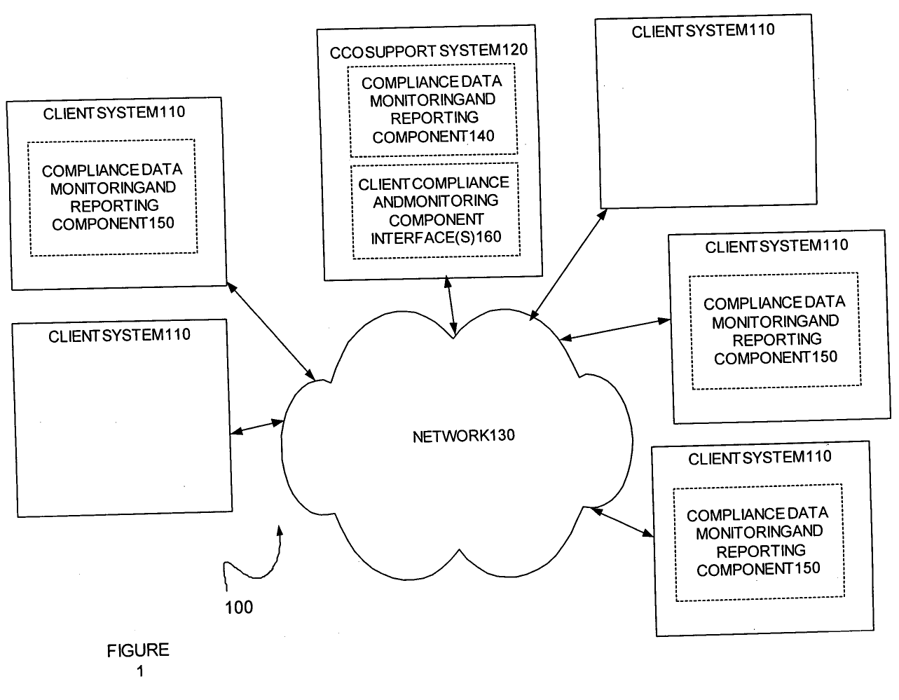

In accordance with at least one embodiment of the invention, the service delivery mechanism for such a CCO Support System may be web-based. Thus, as illustrated in FIG. 1, an environment 100 may allow one or more Clients of an organization providing the CCO Support System, which may include their own systems referred to as Client systems 110, with access to the CCO Support System 120 via a communication network 130, which can be, for example, implemented in whole or part by the Internet and/or like networks. Additionally, a CCO may access services and information provided by the CCO Support System by accessing and interacting with one or more web-pages associated with or provided by the CCO Support System, to input information for analysis by the CCO Support System components and to review output information displayed thereon.

As illustrated in FIG. 1, such Client systems 110 may or may not include their own in-house compliance data monitoring and reporting component, which may provide compliance data monitoring and reporting as required by various statutes and SEC regulations and guidelines. The CCO Support System 120 may be implemented using one or more servers (e.g., one or more server farms, a hierarchically configured server system where a first server acts as a proxy that receives requests from a number of users and routes the requests to appropriate server(s), etc.).

As illustrated in FIG. 1, a user (e.g., a Client CCO) may access the communication network 130 via the Client system 110. The Client system 110 may include any type of data processing device resident with a user, e.g., a PDA, a mobile phone, or other computer equipment resident at a user premises including, for example, a personal computer, etc. The communication network 130 may include, among other things, one or more public networks, such as the Internet, and/or one or more private networks often referred to as “Intranets” and “Extranets.” A connection between the Client system 110 and the communication network 130 may be provided by, for example, the Client's communication network, an Internet connection via a modem included in the Client system 110 and connected to traditional phone lines, an ISDN link, a T1 link, a T3 link, via cable television, via an ethernet network, etc.; that connection may be made, for example, via a third party, such as an Internet Service Provider (ISP) or wireless network. The connection may be made, for example, either by a direct connection of the Client/user to the Internet or indirectly via another, intermediary, device connected to the Internet; in the latter case, the Client system 110 may be connected to the intermediary device via a Local or Wide Area Network (LAN or WAN).

A user may access the CCO Support System 120 by establishing a connection, e.g., a TCP connection, between the Client system 110 and the CCO Support System 120. The Client system 110 may communicate with the CCO Support System 120 using, for example, HTTP protocol over such a TCP connection, to facilitate data transfer between the Client system 110 and the CCO Support System 120. Thus, communication between the CCO Support System 120 and the Client system 110 may be facilitated via a browser included in the Client system 110.

As explained above, in accordance with at least one embodiment of the invention, the CCO Support System performs analysis and generates data, reports and alerts based on fund accounting information maintained by the organization providing the CCO Support System on behalf of its Client(s) and their CCO(s) using a compliance data monitoring and reporting component 140 (illustrated in dashed lines to signify it only as an option associated with at least the first embodiment of the invention) that interfaces with fund accounting components. The Client may have either outsourced the fund accounting responsibilities to the CCO Support System organization, thereby eliminating the need to transmit data to the CCO Support System in order for that system to perform analysis and generate alerts and reports, or the CCO Support System may perform analysis based on Client′ fund accounting records generated by a Client's compliance data monitoring and reporting component 150 (illustrated in dashed lines to signify it only as an option associated with at least the first embodiment of the invention); in the latter case, the CCO Support System has access to, at least periodically and in a timely manner (e.g., at set times throughout a business day and subsequent to daily market closings), the Client's fund accounting information generated by the component 150 in order to generate alerts and report data on a timely basis via the CCO Support System. Accordingly, in such an implementation, the CCO Support System includes one or more interfaces 160 to Clients' fund accounting systems (illustrated in dashed lines to signify it only as an option associated with a configuration in which the CCO Support System is utilizing), and therefore, relying on, a Client's own fund accounting records.

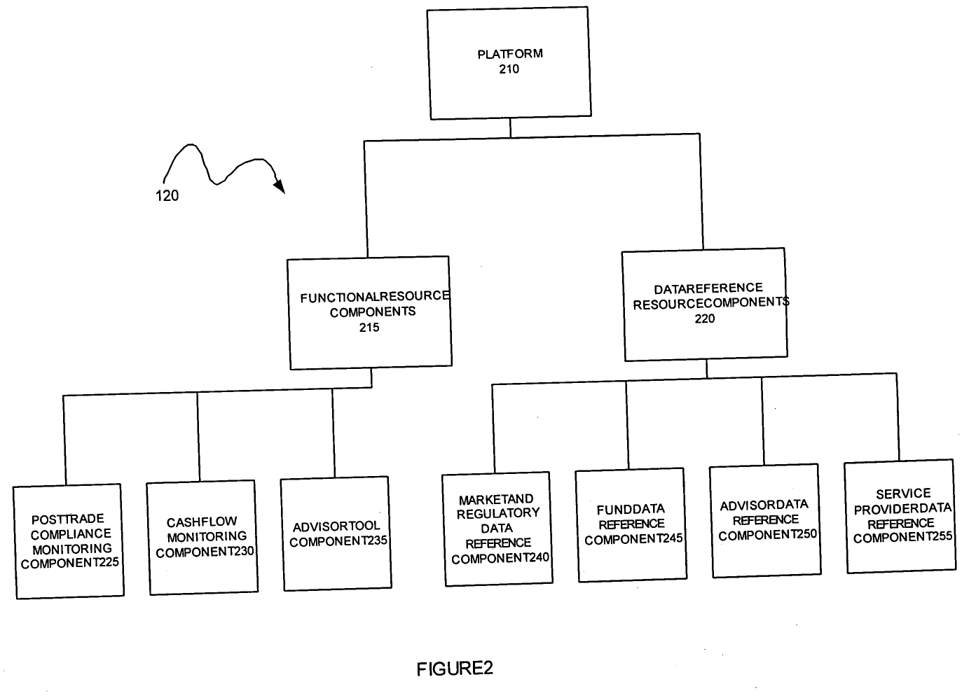

As illustrated in FIG. 2, a CCO Support System 120 may be configured in a hierarchical architecture in which the support system is implemented as part of or on a platform 210 providing Internet-based information delivery and security trading and transaction reporting to Clients. The platform 210 may be implemented as a web-based portal that includes and/or provides access to information provided by the organization maintaining and/or operating the CCO support system. Thus, the CCO Support System may be easily accessed through an integrated information delivery platform. That platform 210 may also provide access to data that is not that organization's own data but is related to the transactions supported by that organization; therefore, the platform may provide access to one or more systems for facilitating trading of securities and other financial instruments in a market. Such a platform 210 may be implemented as part of, in conjunction with or separate from an accounting platform that supports the daily fund accounting needs of the Clients of the organization providing the CCO Support System. Thus, the CCO Support System enables a user to link to other compliance services including those related to custody, fund accounting and data recordation.

Thus, the platform 210 may functionally provide a portal to information and services provided and/or maintained by the organization associated with the CCO Support System. Therefore, the Support System may provide and/or incorporate both functional resource components 215 and data reference resource components 220 (implemented, for example, using one or more software applications running on the platform 210 and accessing data stored in one or more data repositories implemented in databases and other memory maintained by the organization associated with the CCO Support System and other organizations).

The cash flow monitoring component 230 may be included in various functional resource components 215 also including, for example, a post trade compliance monitoring component 225 and an advisor tool component 235. Similarly, the data reference resource components 220 may include, for example, a market and regulatory data reference component 240, a fund data reference component 245, an advisor data reference component 250, and a service provider data reference component 255. As a result, the CCO Support System may provide high level functional reporting, specifically designed for a CCO to assist in the monitoring, analysis and recordation of a number of pieces of information required by various rules and regulations mandated by the SEC. Such monitoring and analysis may also be provided on an ad hoc reporting basis by the manual running of reports using the resources provided by the CCO Support System's report center by Client CCOs. The cash flow monitoring mechanism 230 may also be configured to generate summary alert data 320 that may include various information associated with cash flow monitoring alerts triggered during a particular period of time, e.g., on a particular day, during a particular week, month, quarter or year. Thus, the CCO Support System may include components configured to deliver functional data, on a timely basis, to assist a Client's CCO in measuring the effectiveness of fund and advisor policies and procedures designed to prevent the violation of federal securities laws.

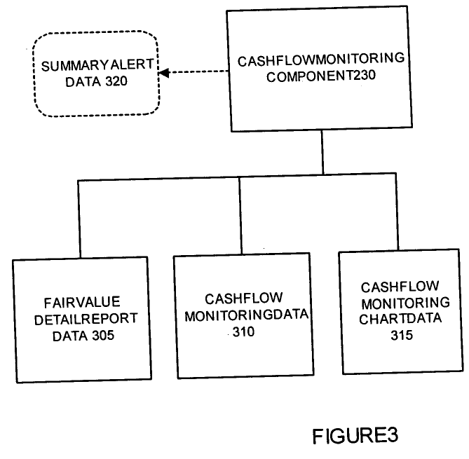

Turning to the specifics of the cash flow monitoring mechanism, as illustrated in FIG. 3, it may include or provide access to, for example, fair value detail report data 305, cash flow monitoring data 310 and cash flow monitoring chart data 315.

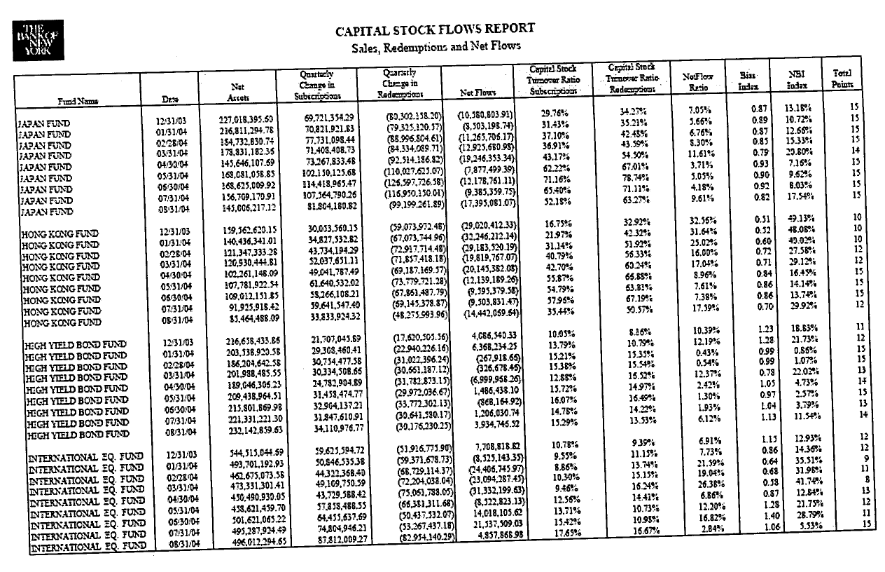

Cash flow monitoring data 310 may include data listings associated with trading in one or more markets. For example, FIG. 4, data may include various pieces of recorded information in association with transactions including an account number associated with the transaction(s), the name(s) of the fund(s) purchased or sold and the date(s) of transaction(s). The data 310 may also include the net asset value(s), the net flow ratio(s), capital stock turnover ratio(s) for subscriptions, capital stock turnover ratio(s) for redemptions, turnover ratio spread(s), netflow ratio(s), bias index(s), Net Bias Index(s) (NBI) at the time(s) of the transaction(s).

Additionally, the cash flow monitoring data may include a score or other indicia indicating the possibility of whether a fund(s) involved in a transaction(s) is potentially the subject of market timing practices. For example, as explained herein one or more algorithms may be used to analyze the other cash flow monitoring data 310 (and potentially other data as well) to determine points relating to the presence, absence, level, degree or trend of certain characteristics associated with a fund at a particular point in time, e.g., net flow ratios, turnover ratios, ratio spreads, indexes, etc. For example, a low NBI may be indicative of “churning,” i.e., the activity of repeatedly buying and selling shares to make profit on short term changes in share sales prices. As a result, analyzing a fund's NBI at a given point in time may provide an indication, albeit a limited, one dimensional one, of whether market timing activity is occurring. By totaling points associated with many such fund characteristics, a multi-dimensional indication may be provided of whether a fund is subject to market timing practices at a particular point in, or over a period of, time (as explained herein).

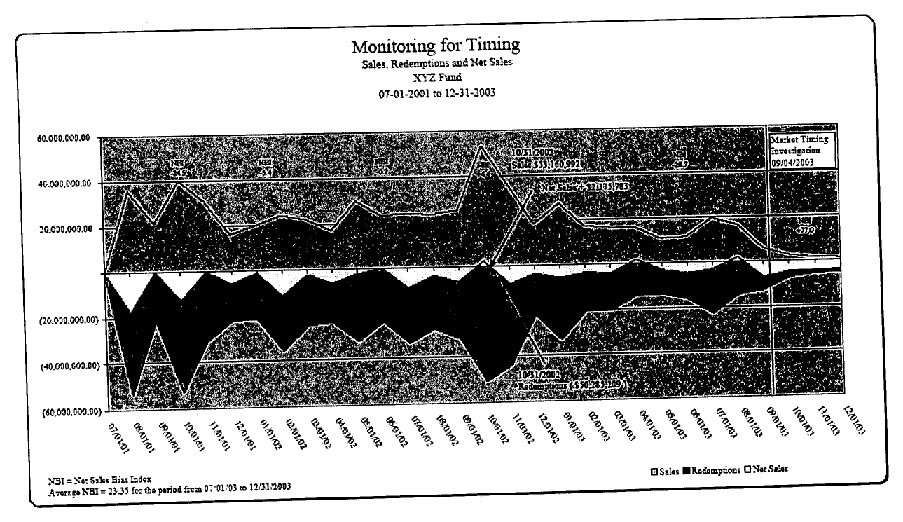

One of the requirements of 38(a)-1 of the Investment Company Act (originally enacted 1940), requires that a fund must have procedures reasonably designed to ensure compliance with its disclosed policies regarding market timing. These procedures should provide for monitoring of shareholder trades or flows of money in and out of the funds in order to detect market timing activity . . . Thus, cash flow monitoring chart data 315 may include data necessary to produce a chart such as the one illustrated in FIG. 5 discussed herein and include the information necessary to enable satisfaction of the requirements of Section 38(a)-1 of the Investment Company Act (originally enacted 1940).

As illustrated in FIG. 5, a potential configuration of a chart may include information associated with surveillance for market timing generated as a result of performing one or more cash flow monitoring algorithms on market transaction data. FIG. 5 illustrates one example of a potential configuration of a chart as generated by the cash flow monitoring mechanism 230 and including data indicating the sales, redemptions, net sales of equity, hybrid and bond funds for industry capital stock activity. Such a graphical representation of, for example, data recorded for performing monitoring for market timing issues including sales, redemptions, and industry capital stock activity, may be configured to allow a user to excite (i.e., click on a particular point or region of the graphical representation to trigger display of additional data (in textual or graphical form) associated with that point or region. Providing a Client CCO with this ability to chart data provided by the compliance system and fund accounting components allows for high level monitoring of data as well as charting and drill-down analysis of data details.

Returning to the explanation associated with FIG. 3, it should be understood that all of the data 305-315 may be utilized in performing the functions of the cash flow monitoring component described in connection with FIG. 3.

An explanation is now provided of one potential implementation of the cash flow monitoring mechanism as it utilizes one or more algorithms to analyze market data associated with transactions relating to a particular fund. Specifically, one or more algorithms may be used individually or in combination to assign a score to fund transaction data generated over a period of time; such a score may be used by fund administrators as an indication as to whether market timing activities which significant to a fund may be taking place.

In such an implementation, point values may be determined and attributed to categories of observed fund-level capital stock activity. The measured level of activity in a particular category may be determined and compared to predetermined ranges of activity levels. Based on that comparison, the measured level of activity may be assigned a score value associated with the predetermined range for that particular category of fund activity. This exercise may be performed for one or more categories of fund activity. Subsequently, the point values for the various categories are totaled to provide a total point value or score. That value is then considered as an indication of whether market timing activity is taking place which may be significant to the fund.

By way of example, the surveillance mechanism may be configured to evaluate the capital stock turnover ratio for subscriptions, capital stock turnover ratio for redemptions, the net flow ratio, the bias index and the net bias index over some period of time, e.g., quarterly, when performing surveillance analysis. Thus, the capital stock turnover ratio for subscriptions data to be analyzed would indicate the ratio of fund subscriptions for the most recently ended three-month period divided by the average net fund assets (e.g., total of the month-end net assets for the three months of the quarter divided by three). If the resulting ratio was greater then 15% then a score of three points may be awarded; a ratio of 10% to 15% may receive a score of two points; a ratio of less then 10% may receive a score of one point.

Similarly, the capital stock turnover ratio for redemptions data to be analyzed would indicate the ratio of fund redemptions for the most recently ended three-month period divided by the average net fund assets (e.g., total of the month-end net assets for the three months of the quarter divided by three). If the resulting ratio was greater then 15% then a score of three points may be awarded; a ratio of 10% to 15% may receive a score of two points; a ratio of less then 10% may receive a score of one point.

The net flow ratio data to be analyzed indicates the net ratio between fund subscriptions and redemption for the most recently ended three-month period divided by the absolute value of the sum of subscriptions plus redemptions for the most recently ended three-month period. If the resulting ratio was less then 15% then a score of three points may be awarded; a ratio of 15% to 25% may receive a score of two points; a ratio of greater then 25% may receive a score of one point.

The bias index may be calculated by dividing the capital stock turnover ratio for subscriptions by the capital stock turnover ratio for redemptions. The bias index provides an indication of any bias of capital stock activity towards either subscriptions or redemptions. If subscriptions and redemptions are equal, the bias index is one. A bias index of greater then one indicates a bias towards subscriptions while a bias index less then one indicates a bias towards redemptions. If the bias index is within the range of 0.80 to 1.20, a score of three points may be awarded. If the bias index is within the ranges of 1.21 to 1.70 or 0.50 to 0.79, a score of two points may be awarded. If the bias index is greater then 1.70 or less then 0.50, a score of one point may be awarded.

To the contrary, the net bias index may be calculated by dividing the net flow (i.e., which is subscriptions minus redemptions) divided by either subscriptions or redemptions, depending on whether or not the net flow is positive or negative. The net bias index is an indication of the bias of net flows relative to the greater of subscriptions or redemptions. If the net bias index is less then 25%, a score of three points may be awarded. If the net bias index is within the range of 25% to 40%, a score of two points may be awarded. If the net bias index is greater then 40%, a score of one point may be awarded.

The points awarded in each of the categories are totaled to provide a total point value, which may be used as an indication of whether the fund is being subjected to significant market timing activity over the period for which the analysis was performed. In the example, the maximum total number of points possible is fifteen while the minimum is five. Thus, the closer the total point number is to the maximum, the more likely the fund is being subjected to significant market timing activity.

However, the scoring is merely an indication of market timing activity. Additionally, activities affecting the subscriptions and redemptions for a particular fund vary over time and between funds. Therefore, it may not be advisable to associate a particular score with an unequivocal determination that significant market timing activity is taking place or that such activity is affecting the value of a fund. Accordingly, the scoring algorithm explained herein merely provides additional information for review by firm administrators that allows them to make a more informed decision regarding whether additional steps are required to guard a fund's value against market timing activities.

It should be understood that the analysis performed by the cash flow monitoring component is based on the aggregate capital stock flows—subscriptions and redemptions—into and out of a fund. As such, that analysis demonstrates the relationship of such positive and negative flows to net assets (“turnover”) and to each other (“net flows”), as well as their directional tendencies (“bias”). While the analysis may provide an indication that significant market timing activity is taking place, it should be understood that that analysis does not provide any assurances that market timing can or will be identified on the basis of the analysis; therefore, the analysis should not be solely relied on for that purpose.

It should be also understood, that the data categories listed in the example are merely for explanation purposes and that, some subset of those data categories and/or additional data categories could be utilized in a scoring algorithm such as that described. The analysis of a larger number of data categories versus a smaller number of data categories is likely to provide a more accurate indication of whether market timing activities are affecting the value of fund; however, that relationship is based on the assumption that all of the analyzed data categories are truly indications of market timing activities. Moreover, multiple algorithms may be used to yield indications of market timing activities based on alternative data analysis theories. For example, the cash flow monitoring component may utilize two or more algorithms that analyze different observed fund-level capital stock activity data to make a determine determination of a likelihood of market timing activities. Use of more then one such algorithm, may allow a more detailed and/or comprehensive review of the cash flow monitoring data. Moreover, such an approach may take into consideration multiple or differing points of view (e.g., by averaging or weighting scores resulting from the plurality of algorithms) regarding what stock activity metrics are actually indicative of market timing activities.

Further, it should be understood that the components described herein may be implemented in many different ways including as software applications that are operating and cooperating on one or more servers maintained by the organization providing the CCO Support System. It should also be understood that these servers may include or interact with large quantities of memory that may store data utilized by and/or generated by the CCO Support System.

Additionally, it should be understood that the system and the results provided by them are intended to provide an indication as to whether market timing significant to a fund may be taking place. Thus, the system cannot provide guaranteed detections of market timing activity.

While the embodiments of the present invention may have been explained with regard to algorithms that provide an indication of whether a fund is subject to market timing practices at a particular point over a period of time, it should be understood that one or more cash flow monitoring algorithms may be used to identify potentially suspicious transactions. Therefore, it should be understood that algorithms may be formulated that focus on a particular fund over a period of time or focus on particular activity relating to different funds over a period of time.

What is claimed is:

1. A system configured to support compliance with fund and advisor policies and procedures designed to prevent the violation of federal securities laws, the system comprising:
at least one functional resource component for determining an indication of whether a fund is potentially being affected by market timing activity, wherein the at least one functional component utilizes at least one algorithm to perform analysis of a plurality of categories of fund transaction data to yield at least one characteristic indicative of the presence of market timing practices.

2. The system of claim 1, wherein the at least one functional resource component is configured to provide an indication of whether a fund is subject to market timing practices over a selected period of time.

3. The system of claim 2, wherein the fund transaction data analyzed by the at least one algorithm is collected over the selected period of time.

4. The system of claim 2, wherein the selected period of time is a quarter of one year.

5. The system of claim 1, wherein the at least one functional resource component is configured to provide an indication of at least one fund transaction that may be associated with market timing practices.

6. The system of claim 1, wherein the at least one functional resource component is configured to generate summary alert data including information associated with a cash flow monitoring alert.

7. The system of claim 1, wherein the at least one functional resource component includes or provide access to fair value detail report data.

8. The system of claim 1, wherein the at least one functional resource component includes or provide access to cash flow monitoring chart data.

9. The system of claim 8, wherein the cash flow monitoring chart data includes information associated with surveillance for market timing generated as a result of performing one or more cash flow monitoring algorithms on market transaction data.

10. The system of claim 1, wherein the at least one functional resource component includes or provides access to cash flow monitoring data.

11. The system of claim 1, wherein the cash flow monitoring data includes recorded information in association with fund share purchase and sale transactions.

12. The system of claim 1, wherein the at least one functional resource component is configured to compare cash flow monitoring data with predetermined ranges of activity levels to assign point values for at least one data category of observed fund-level capital stock activity.

13. The system of claim 12, wherein the at least one functional resource component is configured to total point values from a plurality of data categories of observed fund-level stock activity to provide the at least one characteristic indicative of the presence of market timing practices.

14. The system of claim 12, wherein the at least one data category of observed fund-level capital stock activity is a capital stock turnover ratio for subscriptions, a capital stock turnover ratio for redemptions, a net flow ratio, a bias index or a net bias index.

15. A functional resource component configured to support compliance with fund and advisor policies and procedures designed to prevent the violation of federal securities laws, the component being configured to determine an indication of whether a fund is potentially being affected by significant market timing activities, wherein at least one functional component utilizes at least one algorithm to perform analysis of a plurality of categories of fund transaction data to yield at least one characteristic indicative of the presence of market timing practices.

16. The functional resource component of claim 15, being further configured to provide an indication of whether a fund is subject to market timing practices over a selected period of time.

17. The functional resource component of claim 16, wherein the at least one functional resource component is configured to compare cash flow monitoring data with predetermined ranges of activity levels to assign point values for at least one data category of observed fund-level capital stock activity.

18. The functional resource component of claim 16, being further configured to provide an indication of at least one fund transaction that may be associated with market timing practices.

19. The functional resource component of claim 18, being further configured to total point values from a plurality of data categories of observed fund-level stock activity to provide the at least one characteristic indicative of the presence of market timing practices.

20. A method for supporting compliance with fund and advisor policies and procedures designed to prevent the violation of federal securities laws, the method determining an indication of whether a fund is potentially being affected by significant market timing activities, the method comprising:
comparing cash flow monitoring data with predetermined ranges of activity levels in a plurality of data categories of observed fund-level capital stock activity;
assigning point values for the cash flow monitoring data in each of the plurality of data categories of observed fund-level capital stock activity; and
totaling the point values assigned to each of the plurality of data categories of observed fund-level capital stock activity to provide the determined indication of whether the fund's value is potentially being affected by market timing practices.

21. The method of claim 20, wherein the determined indication further indicates whether a fund is subject to market timing activity over a selected period of time.

22. The method of claim 20, wherein the determined indication further indicates at least one fund transaction that may be associated with market timing practices.
